(19) United States
(12) Patent Application Publication
(10) Pub. No.: US 2017/0305794 A1
(43) Pub. Date: Oct. 26, 2017

(54) Improvements in the Deformation Resistance of Timber Frame Partitions

(71) Applicant: Saint-Gobain Placo SAS, Suresnes (FR)

(72) Inventor: Joanna Sparkes, Coventry (GB)

(21) Appl. No.: 15/517,259

(22) PCT Filed: Oct. 9, 2015
(86) PCT No.: PCT/GB2015/052971

§ 371 Date: Apr. 6, 2017

(30) Foreign Application Priority Data
Oct. 9, 2014 (GB) 1417904.8

(51) Int. Cl. C04B 28/14; E04C 2/04; E04C 2/38; E04C 2/06; C04B 111/00

(52) U.S. Cl. CPC C04B 28/14; E04C 2/386; E04C 2/06; E04C 2/043; C04B 2111/00629; C04B 2111/0062

(57) ABSTRACT

A partition for a building structure comprises a support frame and a plasterboard affixed to the support frame. The support frame comprises a plurality of elongate timber members. The plasterboard comprises a gypsum matrix having fibres embedded therein in an amount of at least 1 wt % relative to the gypsum, as well as a polymeric additive that is present in an amount of at least 1 wt % relative to the gypsum.

### FIELD OF THE INVENTION

The present invention relates to timber frame-based partitions have improved resistance to deformation, in particular to partitions having improved resistance to wind loading.

### BACKGROUND TO THE INVENTION

Gypsum sheathing boards are often less preferred for use in timber frame construction, because they do not provide the structure with sufficient resistance to wind loading to meet regulatory requirements. Therefore, other boards such as oriented strand board and plywood have previously been used.

Resistance to wind loading is generally characterised through the racking strength of the board, that is, the ability of the board to resist shear loading in the plane of the board. Racking strength is difficult to predict, as it does not correlate closely with other mechanical parameters.

It desirable to provide gypsum-based boards having improved racking strength, such that they may be used in timber frame construction.

### SUMMARY OF THE INVENTION

It has been found that gypsum-based plasterboard containing high levels of fibre and at least one polymeric additive have increased levels of racking resistance.

Therefore, in a first aspect, the present invention may provide a partition for a building structure, the partition comprising a support frame and at least one plasterboard affixed to the support frame, wherein:

the support frame comprises a plurality of elongate timber members; and

the plasterboard comprises a gypsum matrix having fibres embedded therein in an amount of at least 1 wt % relative to the gypsum, the gypsum matrix further comprising a polymeric additive that is present in an amount of at least 1 wt % relative to the gypsum.

Preferably, the fibres are present in an amount of at least 3 wt % relative to the gypsum, more preferably in an amount of at least 5 wt % relative to the gypsum.

Preferably, the polymeric additive is present in an amount of at least 3 wt % relative to the gypsum, more preferably in an amount of at least 5 wt % relative to the gypsum.

It has been found that the use of relatively short fibres helps to promote an even distribution of fibres throughout the board, which has a beneficial effect on racking resistance. Thus, it is preferred that the fibre length is less than 20 mm, preferably less than 15 mm, more preferably less than 10 mm. The fibre length is preferably greater than 1 mm. Preferably, the fibres are glass fibres.

Preferably, the plasterboard is provided with a backing lamina such as a fibreglass sheet.

The lamina represents a layer that provides a discrete component of the panel, that is, it is not integrally formed with the substrate. Effectively, there is a well-defined interface or boundary between the substrate and the lamina.

Typically, the lamina has a thickness of at least 0.25 mm, preferably at least 0.5 mm, more preferably at least 1 mm. Typically, the thickness of the lamina is less than 4 mm, preferably less than 3 mm, more preferably less than 2.5 mm.

In certain cases, the polymeric additive is a starch. In other cases, the polymeric additive is a synthetic polymer such as polyvinyl acetate.

Typically, the racking stiffness of the partition, measured in accordance with British standard BS EN 594:1996 is greater than 1500 N/m, preferably greater than 2000 N/m.

The plasterboard is prepared through a process comprising mixing stucco and water to form a stucco slurry, and allowing the slurry to set. Thus, the plasterboard is distinguished from boards such as fibreboard, which are prepared through a process of mixing water, fibres and calcium dihydrate to form a slurry, heating the slurry to calcine the gypsum, removing water from the slurry to form a filter cake, and forming the filter cake into the desired shape prior to the complete setting of the calcined gypsum.

### DETAILED DESCRIPTION

The invention will now be described by way of example with reference to the following Figures in which:

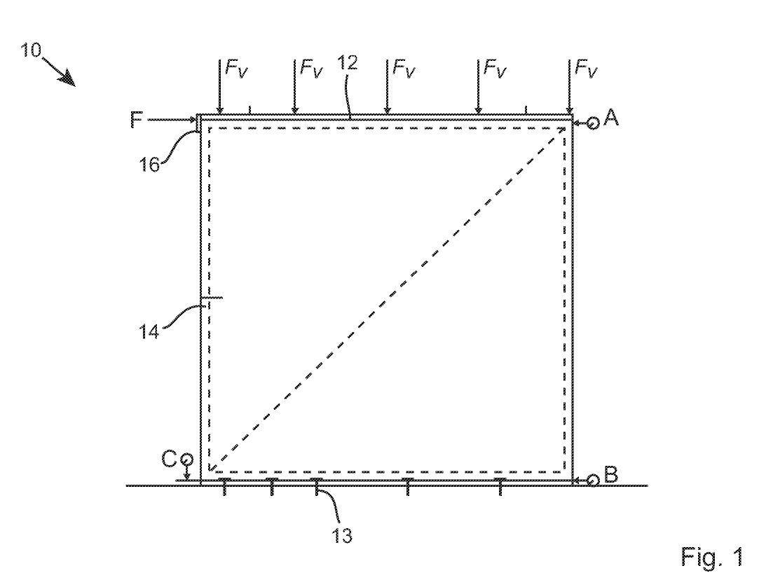

FIG. 1 shows a schematic elevation view of a test apparatus for measuring racking resistance.

### TESTING RACKING RESISTANCE OF BOARDS

Racking resistance was measured in accordance with British standard BS EN 594:1996.

Referring to FIG. 1, a 2400 mm high×2400 mm long test specimen 10 was constructed and placed within the test rig. The test specimen comprised a frame consisting of 90 mm×38 mm cross-section timber top and bottom rails, and 90 mm×38 mm cross-section timber studs extending therebetween at 600 mm intervals. A head binder 12 was rigidly attached to the top and bottom rails. The test specimen was bolted into the test rig by means of bolts 13 inserted through the bottom rail of the frame.

Plasterboard sheathing 14 was fixed to the frame in a single layer below the head binder. The boards were screw fixed with 41 mm British Gypsum drywall timber screws at 300 mm intervals around the perimeter of the boards.

In a first loading step, a downward vertical pre-load Fᵥ was applied to the test specimen at the positions of the studs. This load was subsequently removed. In a second loading step, a racking load F was applied horizontally to the top of the test specimen onto a metal plate 16 attached to the top rail of the panel and the head binder. The deformation d of the board was measured as the displacement at transducer A minus the displacement at transducer B.

The racking stiffness is calculated as the ratio of racking load F to the deformation d of the board.

### EXAMPLES

### Example 1

A plasterboard having a gypsum core containing the following additional components:
3 wt % 6 mm glass fibre
6 wt % starch (a mixture of Amidon MB065X from Roquette and Coatmaster K57 ethylated starch from Grain Processing Corporation)
a water-resistant additives: silicone oil and cement
biocide: sodium omadine

The board has a thickness of 12.5 mm and a weight of 12.3 kg/m².

The board has a liner provided by a pre-coated glass mat having a weight of 360 g/m² and a mineral coating.

### Example 2

A plasterboard having a gypsum core containing the following additional components:
3wt % of 12 mm glass fibre
3wt % starch (a mixture of Amidon MB065X from Roquette and Coatmaster K57 ethylated starch from Grain Processing Corporation)

The plasterboard has a paper liner on both sides of the board, the liner having a weight of 240 g/m², and additionally a backing lamina provided by a 1.5 mm fibre glass sheet. The total thickness of the composite board (including the gypsum board and the backing lamina) is 15 mm. The total weight of the composite board is 15.6 kg/m².

### Example 3

A plasterboard having a gypsum core containing the following additional components:
3 wt % of 6mm glass fibre; and
5 wt % starch (Merifilm starch from Tate & Lyle).

The plasterboard has a paper liner on each side of the board. The weight of the paper liner is 190 g/m² on the side of the board facing away from the support frame and 180 g/m² on the side of the board facing towards the support frame. It is 12.5 mm thick product with a weight of approx. 12 kg/m².

### Comparative Example 1

A plasterboard having a gypsum core containing the following additional components:
0.5 wt % of 12 mm glass fibres

The board has a liner provided by a pre-coated glass mat. The weight of the board is 11 kg/m².

Results

| | Mean | | |
|---|---|---|---|
| | racking | Mean racking | |
| Example | stiffness | strength | Failure mode |
| 1 | 2426 N/mm | 8726 N | 2 studs detached from rail |
| 2 | 3108 N/mm | 14044 N | 3 studs detached from rail |
| 3 | 3652 N/mm | 9989 N | 2 studs detached from rail |
| Comparative | 1122 N/mm | 4666 N | Screws pulled through |
| example 1 | | | board |

1. A partition for a building structure, the partition comprising a support frame and at least one plasterboard affixed to the support frame, wherein:
the support frame comprises a plurality of elongate timber members; and
the plasterboard comprises a gypsum matrix having fibres embedded therein in an amount of at least 1 wt % relative to the gypsum, the gypsum matrix further comprising a polymeric additive that is present in an amount of at least 1 wt % relative to the gypsum.

2. The partition of claim 1, wherein the fibres are present in an amount of at least 3 wt % relative to the gypsum.

3. The partition of claim 1, wherein the polymeric additive is present in an amount of at least 3 wt % relative to the gypsum.

4. The partition of claim 3, wherein the polymeric additive is present in an amount of at least 5 wt % relative to the gypsum.

5. The partition of claim 1, wherein the fibres are present in an amount of about 3 wt % relative to the gypsum and the polymeric additive is present in an amount of about 5 wt % relative to the gypsum.

6. The partition of claim 1, wherein the plasterboard has a backing lamina attached to one of the faces thereof.

7. The partition of claim 6, wherein the backing lamina has a thickness greater than 1 mm.

8. The partition of claim 6, wherein the backing lamina is a fibreglass lamina.

9. The partition of claim 1, wherein the fibres are glass fibres.

10. The partition of claim 9, wherein the fibres have an average length less than 12 mm.

11. The partition of claim 10, wherein the fibres have an average length less than 10 mm.

12. The partition claim 1, wherein the polymeric additive is a starch.

13. The partition of claim 1, wherein the polymeric additive is polyvinyl acetate.

14. The partition of claim 1, having a racking stiffness, measured in accordance with British standard BS EN 594:1996, that is greater than 1500 N/m.

15. The partition of claim 14, wherein the racking stiffness is greater than 2000 N/m.

16. A partition for a building structure, the partition comprising a support frame and at least one plasterboard affixed to the support frame, wherein:
the support frame comprises a plurality of elongate timber members; and
the plasterboard comprises a set uncalcined gypsum plaster matrix having fibres embedded therein in an amount of at least 1 wt % relative to the set uncalcined gypsum plaster matrix, the set uncalcined gypsum plaster matrix further comprising a polymeric additive that is present in an amount of at least 1 wt % relative to the set uncalcined gypsum plaster matrix.

17. The partition of claim 16, wherein the fibres are present in an amount of about 3 wt % relative to the gypsum and the polymeric additive is present in an amount of about 5 wt % relative to the gypsum.

18. The partition of claim 16, wherein the fibres have an average length less than 12 mm.

19. The partition of claim 16, wherein the polymeric additive is at least one of starch and polyvinyl acetate.

20. The partition of claim 16, wherein the plasterboard has a racking stiffness, measured in accordance with British standard BS EN 594:1996, that is greater than 1500 N/m.
